(19) United States
(12) Patent Application Publication
(10) Pub. No.: US 2025/0092935 A1
(43) Pub. Date: Mar. 20, 2025

(54) LINK DEVICE AND TRACK

(71) Applicant: Caterpillar SARL, Geneva (CH)

(72) Inventors: Seiji IIJIMA, Akashi-shi (JP); Yasuo YAMASHITA, Akashi-shi (JP); Yu MATSUMOTO, Akashi-shi (JP); Chad M. ARNOLD, Peoria, IL (US)

(73) Assignee: Caterpillar SARL, Geneva (CH)

(21) Appl. No.: 18/884,621

(22) Filed: Sep. 13, 2024

(30) Foreign Application Priority Data
Sep. 14, 2023 (JP) 2023-149443

(51) Int. Cl. F16G 13/07

(52) U.S. Cl. CPC F16G 13/07

(57) ABSTRACT

Problems: Provided is a link device capable of forming links at a low cost and appropriately sealing a lubricant, and a track including the same. Solutions: In a link device, a fitting portion into which a seal member is fitted is formed on at least one of an end portion of a bush and a periphery of a second hole portion of a link facing the end portion of the bush via a gap 46, and due to axial deformation of the seal member fitted into the fitting portion, the end portion of the bush is capable of being supported by a support member which is harder than the seal member.

### FIELD OF THE INVENTION

The present invention relates to a link device in which a plurality of links are coupled via a bush and a pin, and to a track including the same.

### BACKGROUND OF THE INVENTION

In the related art, a link device in which a plurality of links are endlessly coupled to one another via a bush and a pin in a track used in a tracked vehicle such as a hydraulic excavator (see, for example, Patent Documents 1 and 2).

In order to increase the life of the link device, a lubricant such as grease or lubricating oil is generally sealed in a gap between the pin and the bush. In order to prevent soil contamination caused by leakage of the sealed lubricant, it is necessary to provide a sealing unit on an end portion of a contact surface between the pin and the bush.

As a general seal unit, for example, as described in Patent Document 1, a counterbored portion having a larger diameter than a pin is provided on an inner periphery of a pin hole in a link, a seal member having a W-shaped cross section is attached to the counterbored portion, and an entire bush end portion is disposed so as to come into contact with the seal member.

### PRIOR ART DOCUMENTS

### Patent Document

Patent Document 1: JP2022-86317A
Patent Document 2: JPH08-324466A

### SUMMARY OF THE INVENTION

### Problems to be Solved by the Invention

In the case of the above-described structure, a depth is required for the counterbored portion in which the bush is to be mounted, and a pin press-fit allowance is required for press-fitting the pin into the link, so thickness is required around the pin hole in the link.

For example, as in the configuration described in Patent Document 1, when a base material of the link is manufactured by a method such as forging or casting, it is possible to form a partially thick angle-shaped boss portion around the pin hole. However, as in Patent Document 2, when the link is manufactured from a rolled material, it is not possible to make only the area around the pin hole thicker, so the entire rolled material becomes thick, and an increased volume of the base material also increases a cost. In addition, in the case of the seal member having the W-shaped cross section, since a structure is designed to bear an entire load of the link in a direction of rotation axis, not only is it unavoidable for the link device to be large, but it also makes the seal member more susceptible to wear, which is one of the factors that affects the lifespan of the link device.

The present invention has been made in view of such a point, and an object thereof is to provide a link device in which a link can be formed at a low cost and a lubricant can be appropriately sealed, and a track including the same.

### Means for Solving the Problem

The invention according to claim 1 is a link device including a plurality of links formed of a rolled material and having a plurality of hole portions; a bush press-fitted into the hole portion of the link; a pin that couples one link and another link by being press-fitted into a hole portion of the other link through the bush press-fitted in the hole portion of the one link; and an annular seal member that seals a lubricant interposed between the pin and the bush, in which a fitting portion into which the seal member is fitted is formed on at least one of an end portion of the bush and a periphery of the hole portion of the link facing the end portion of the bush via a gap, and due to axial deformation of the seal member fitted into the fitting portion, the end portion of the bush is capable of being supported by a support member which is harder than the seal member.

The invention according to claim 2 is the link device according to claim 1 in which the fitting portion is a groove portion formed on at least one of an end surface of the bush and a side portion of the periphery of the hole portion of the link.

The invention according to claim 3 is the link device according to claim 1 in which the fitting portion is a chamfered portion formed on at least one of a hole edge of the bush and a hole edge of the link.

The invention according to claim 4 is a track including the link device according to any one of claims 1 to 3 in which the plurality of links are endlessly coupled via the bush and the pin; and a shoe attached to the links of the link device.

### Effect of the Invention

According to the invention according to claim 1, the link can be formed at a low cost and the lubricant can be appropriately sealed.

According to the invention according to claim 2, the fitting portion can be easily formed, and a configuration can be easily achieved in which axial deformation of the seal member fitted into the fitting portion enables contact between the end portion of the bush and the support member by setting a shape of the fitting portion and an allowable deformation amount of the seal member.

According to the invention according to claim 3, the fitting portion can be easily formed, and a configuration can be easily achieved in which axial deformation of the seal member fitted into the fitting portion enables the contact between the end portion of the bush and the support member by setting the shape of the fitting portion and the allowable deformation amount of the seal member.

According to the invention according to claim 4, it is possible to provide a highly reliable track which is inexpensive and can maintain performance over a long period of time.

### BRIEF DESCRIPTION OF THE DRAWINGS

FIG. 1 is a longitudinal cross-sectional front view showing a first embodiment of a link device and a track including the same according to the present invention.

FIG. 2 (a) is an enlarged longitudinal cross-sectional front view showing a part of the link device, and FIG. 2 (b) is a longitudinal cross-sectional front view showing a state in which a bush and a support member are in contact with each other due to deformation of a seal member.

FIG. 3 (a) is a perspective view showing a link from one side, and FIG. 3 (b) is a perspective view showing the link from the other side.

FIG. 4 is a longitudinal cross-sectional side view showing a part of the track.

FIG. 5 is a perspective view showing an example of a rolled material forming the link.

FIG. 6 is a perspective view showing a part of the track.

FIG. 7 is a side view showing a tracked vehicle equipped with the track.

FIG. 8 is a longitudinal cross-sectional front view showing a part of a second embodiment of the link device according to the present invention.

FIG. 9 is a longitudinal cross-sectional front view showing a part of a third embodiment of the link device according to the present invention.

### DETAILED DESCRIPTION OF THE INVENTION

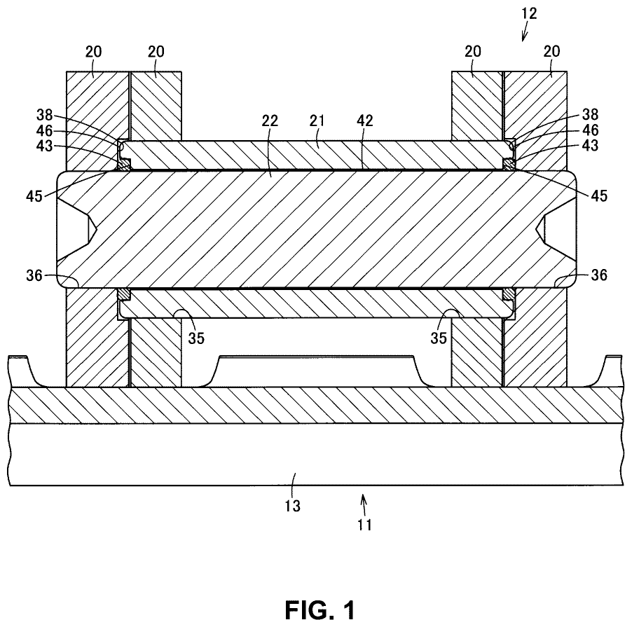

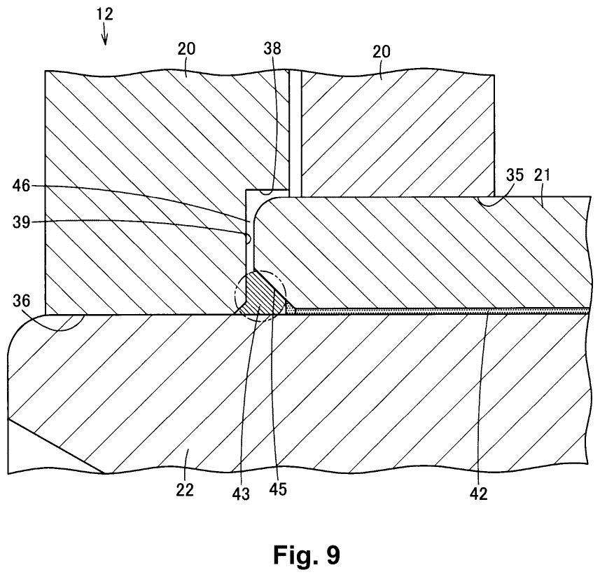

Hereinafter, the present invention will be described in detail based on a first embodiment shown in FIGS. 1 to 7, a second embodiment shown in FIG. 8, and a third embodiment shown in FIG. 9.

First, the embodiment shown in FIG. 1 to FIG. 7 will be described.

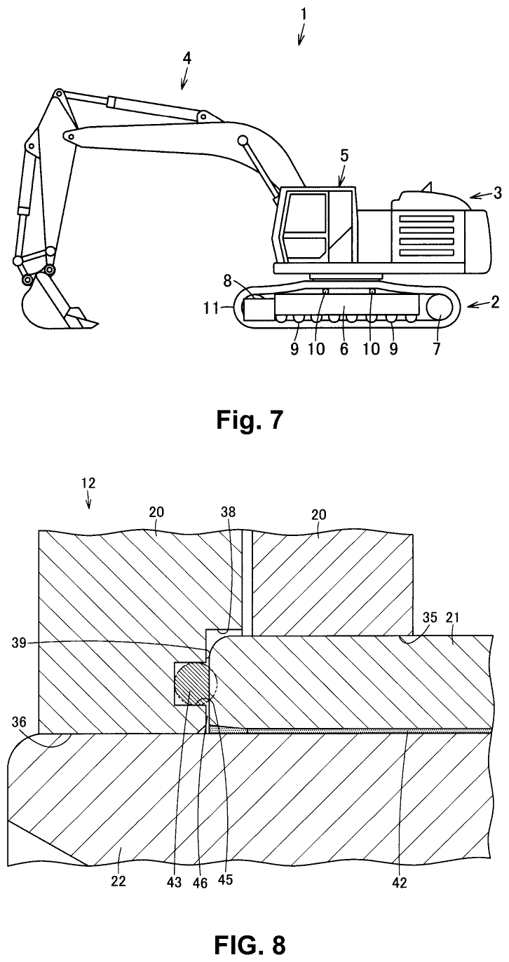

In FIG. 7, 1 denotes a tracked vehicle. In the present embodiment, a hydraulic excavator, which is a working machine, is taken as an example of the tracked vehicle 1. In the tracked vehicle 1, an upper swivel body 3 is swivelably mounted on a lower traveling device 2, and a working device 4 and a cab 5 in which an operator is seated are mounted on the upper swivel body 3.

In the traveling device 2, sprockets 7 driven by a travel motor are respectively supported at ends of track frames 6 provided on left and right sides of a vehicle body, idlers 8 are rotatably supported on the other ends, respectively, a plurality of lower rollers 9 are rotatably supported on a lowside portion, a plurality of upper rollers 10 are rotatably supported on an upside portion, and a track 11 is wound around the sprockets 7, the idlers 8, the lower rollers 9, and the upper rollers 10 on the left and right sides of the vehicle body.

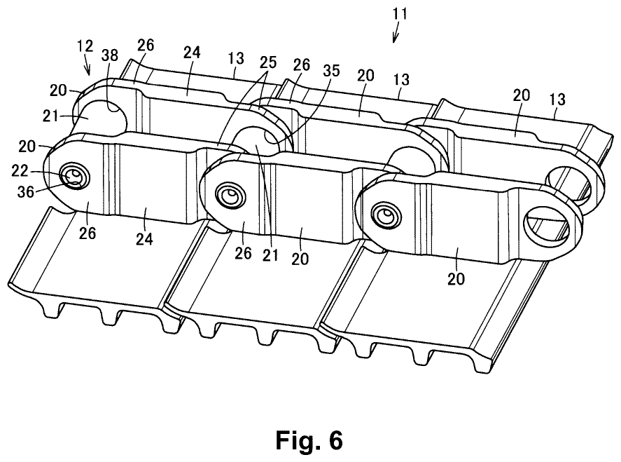

As shown in FIG. 6, the track 11 is formed by hanging and mounting shoes (shoe plates) 13, which are rotating members, to an endless link device 12 that is symmetrical or approximately symmetrical. Further, the shoe 13 is driven to rotate by the link device 12.

The link device 12 is formed by coupling a plurality of plate-shaped links (track links) 20 by cylindrical bushes 21 and columnar pins 22. In the present embodiment, the plurality of links 20 are coupled in sequence to both ends of the bushes 21 and the pins 22. Therefore, links 20, 20 that form a left-right pair are coupled to the other links 20, 20 that form a left-right pair by the bushes 21 and the pins 22. In other words, in the illustrated example, one link device 12 is set at a central portion of the one shoe 13 in a left-right direction.

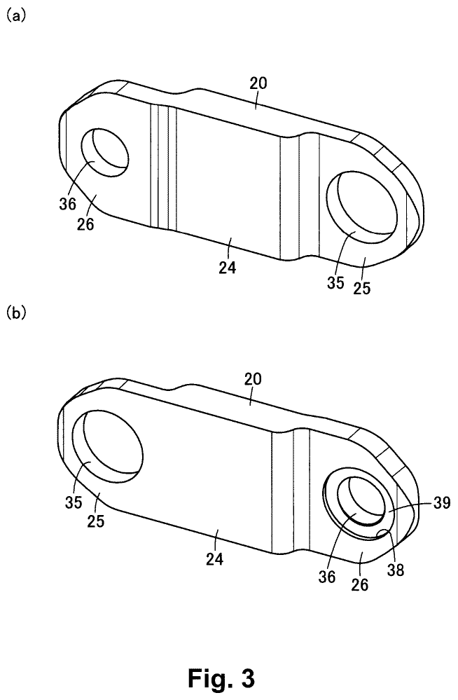

The links 20 shown in (a) and (b) of FIG. 3 are disposed with a thickness direction as the left-right direction, a longitudinal direction as a front-rear direction, and a short direction or a width direction as an up-down direction. Each of the links 20 includes a flat plate-shaped link body 24 that is the thickest, and flat plate-shaped first and second coupling portions 25 and 26 that are thinner than the link body 24. The first coupling portion 25 and the second coupling portion 26 are located on opposite sides with respect to the link body 24. The first coupling portion 25 constitutes one end portion of the link 20, and the second coupling portion 26 constitutes the other end portion of the link 20. In the present embodiment, with respect to the link body 24, the first coupling portion 25 is offset in a step-like manner toward one side in the thickness direction, and the second coupling portion 26 is offset in a step-like manner toward the other end in the thickness direction. In other words, the first coupling portion 25 and the second coupling portion 26 are staggered in the thickness direction with respect to the link body 24. The link 20 is vertically symmetrical or substantially symmetrical, and the left and right links 20 are formed to have the same shape.

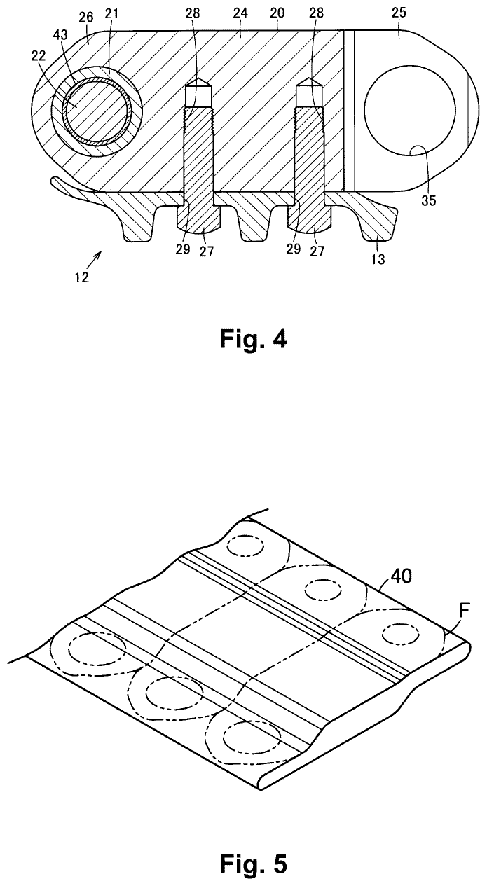

As shown in FIG. 4, the link body 24 is a portion that couples the link device 12 or the link 20 to the shoe 13. In the present embodiment, the link 20 and the shoe 13 are coupled to each other by mounting bolts 27, which are coupling members. For example, in the link body 24, bolt hole portions 28 each having a threaded portion therein into which the mounting bolt 27 is screwed are formed from a lower portion to an upper portion along the up-down direction which is a perpendicular to a rotation axis direction of the link 20. In the illustrated example, the bolt hole portions 28 are formed on a first coupling portion 25 side, that is, one end side, and a second coupling portion 26 side, that is, the other end side of the link body 24, respectively. The mounting bolt 27 inserted from a mounting hole 29 formed in the shoe 13 is inserted and screwed into the bolt hole portion 28, thereby coupling the link 20 to the shoe 13. A coupling structure between the link 20 and the shoe 13 may be freely configured and is not limited to the one using the mounting bolt 27 for the coupling, and the link 20 and the shoe 13 may be coupled to each other by welding or the like.

As illustrated in (a) and (b) of FIG. 3 and FIG. 6, the first coupling portion 25 is also called an inner coupling portion, and is located on an inner side in the thickness direction of the plurality of links 20 coupled to one another. The second coupling portion 26 is also called an outer coupling portion, and is located on an outer side in the thickness direction of the plurality of links 20 coupled to one another. In other words, in the coupled links 20, the second coupling portion 26 of one link 20 is superimposed on an outer side of the first coupling portion 25 of the other link 20.

A first hole portion 35, which is a hole portion into which the bush 21 is press-fitted, is formed in the first coupling portion 25. The first hole portion 35 is formed in a circular shape and passes through the first coupling portion 25 in the thickness direction. The first hole portion 35 slightly has a slight press-fit allowance with respect to an outer diameter of the bush 21. That is, the first coupling portion 25 is formed to have a thickness capable of ensuring the press-fit allowance of the bush 21, and has a substantially constant thickness.

A second hole portion 36, which is a hole portion into which the pin 22 is press-fitted, is formed in the second coupling portion 26. The second hole portion 36 is formed in a circular shape and passes through the second coupling portion 26 in the thickness direction. The second hole portion 36 has a slight press-fit allowance with respect to an outer diameter of the pin 22. That is, the second coupling portion 26 is formed to have a thickness capable of ensuring the press-fit allowance of the pin 22, and has a substantially constant thickness. In the present embodiment, the thickness of the second coupling portion 26 is set to be greater than the thickness of the first coupling portion 25.

The second hole portion 36 is smaller in diameter than the first hole portion 35. A recess 38 into which an end portion of the bush 21 is inserted is recessed and formed in a step-like manner in a periphery of the second hole portion 36. The recess 38 is formed along an outer periphery of the second hole portion 36 on an inside of the second coupling portion 26, that is, on a side facing the first coupling portion 25 of the other link 20. An outer diameter of the recess 38 is slightly larger than the outer diameter of the bush 21. A bottom portion 39 of the recess 38 constitutes a side portion of the link 20 facing the end portion of the bush 21.

In the present embodiment, the link 20 is formed by being cut out from a long rolled material 40 shown in FIG. 5. A stepped shape in the thickness direction between the link body 24 and the first coupling portion 25 and second coupling portion 26 ((a) of FIG. 3) is formed by rolling when the rolled material 40 is formed. From this rolled material, an entire shape F of the link 20 can be obtained by simply cutting out only a peripheral portion at a width corresponding to a height of the link 20 ((a) of FIG. 3) using laser cutting or punching.

The first hole portion 35 and the second hole portion 36 illustrated in (a) and (b) of FIG. 3 may be machined either before or after the link 20 is cut out from the rolled material 40 (FIG. 5). The bolt hole portion 28 shown in FIG. 4 is machined after the link 20 is cut out from the rolled material 40 (FIG. 5).

The bush 21 shown in FIG. 1 is press-fitted between the first hole portions 35 of the left and right links 20. Both end portions of the bush 21 protrude from outer surfaces of the left and right links 20 and are inserted into side portions of the links 20 that are superimposed on outsides of these links 20, in the present embodiment, into the recesses 38.

The pin 22 is press-fitted between the second hole portions 36 of the links 20 that are superimposed on the outsides of the left and right links 20 through the bush 21 that is press-fitted into the left and right links 20. The pin 22 is fitted into the bush 21 with a gap therebetween, and a lubricant 42 such as grease or lubricating oil is interposed in the gap, and the lubricant 42 is sealed by sealing the gap with a seal member 43.

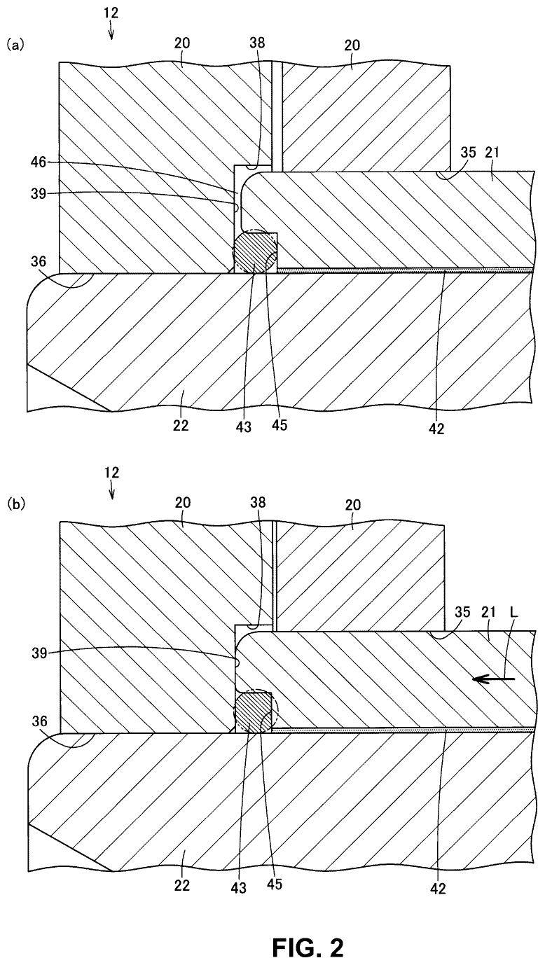

The seal member 43 shown in FIG. 1 and (a) of FIG. 2 is a seal ring formed into an annular shape from an elastic member. The seal member 43 is sandwiched between an end portion of the bush 21 and the periphery of the second hole portion 36 of the link 20, in the present embodiment, the bottom portion 39 of the recess 38.

The seal member 43 is fitted and held in a fitting portion 45. The fitting portion 45 is formed on at least one of the end portion of the bush 21 and the periphery of the second hole portion 36 of the link 20 that faces the end portion of the bush 21 across a gap 46, that is, the bottom portion 39 of the recess 38. For example, the fitting portion 45 is a groove portion formed on at least one of an end surface of the bush 21 and the bottom portion 39 of the recess 38 which is a side portion of the periphery of the second hole portion 36 of the link 20. In the illustrated example, the fitting portion 45 is formed on the end surface of the bush 21. Further, the fitting portion 45 is recessed in an axial hole edge of the bush 21. Therefore, in the present embodiment, one end portion of the seal member 43 fitted to the fitting portion 45 is in contact with the end portion or the end surface of the bush 21, the other end portion is in contact with the bottom portion 39 of the recess 38, and an inner peripheral portion is in contact with an outer peripheral surface of the pin 22.

When an axial load L is applied to a part of the track 11, the seal member 43 fitted to the fitting portion 45 is deformed in an axial direction, and the bush 21 is laterally displaced together with the link 20 by the gap 46, so that as shown in (b) of FIG. 2, the end portion or the end surface of the bush 21 is capable of coming into contact with a support member different from the seal member 43, for example, the bottom portion 39 of the recess 38 of the periphery of the second hole portion 36 of the link 20 in the present embodiment.

Therefore, the seal member 43 preferably has a cross-sectional shape with a large allowable deformation amount (crushing margin). For example, in the present embodiment, the seal member 43 having an O-shaped cross section is used. The present invention is not limited thereto, and the seal member 43 may have a D-shaped cross section or an X-shaped cross section.

Further, a depth and a width of the fitting portion 45 are sized to sufficiently allow deformation of the fitted seal member 43. For example, when the depth of the fitting portion 45 is too large, the seal member 43 is not in proper contact with the end portion or the end surface of the bush 21 and the bottom portion 39 of the recess 38, and sealing cannot be maintained. Further, when the width of the fitting portion 45 is not sufficient, the deformation of the seal member 43 is restricted, and when a force in the axial direction is applied to the track 11, the seal member 43 cannot be sufficiently crushed, and the end portion of the bush 21 and the bottom portion 39 of the recess 38 cannot be brought into contact with each other. In the present embodiment, the gap 46 is set to, for example, about 0.5 mm. Therefore, shapes of the seal member 43 and the fitting portion 45 are set such that an allowable deformation amount of the seal member 43 in the axial direction is 0.5 mm or more.

As described above, in the present embodiment, the fitting portion 45, into which the annular seal member 43 that seals the lubricant 42 interposed between the pin 22 and the bush 21 is fitted, is formed on at least one of the end portion of the bush 21 and the periphery of the second hole portion 36 of the link 20 that faces the end portion of the bush 21 via the gap 46, and the axial deformation of the seal member 43 fitted into the fitting portion 45 allows the end portion or the end surface of the bush 21 to be supported in the axial direction by the support member harder than the seal member 43, for example, the periphery of the second hole portion 36 of the link 20. Since the link 20 has substantially no elasticity, in the present embodiment, the contact between the end portion or the end surface of the bush 21 and the periphery of the second hole portion 36 of the link 20 is inelastic. The present invention is not limited thereto, and the support member may have elasticity as long as the support member is harder than the seal member 43 and less deformable than the seal member 43.

Therefore, when the axial load L is applied to the link device 12 or the track 11, this load L does not have to be borne by the seal member 43 alone, and thus even if the track rotates in this state, the seal member 43 will not wear out, and can be made smaller while still being able to properly seal the lubricant 42. Therefore, it is not necessary to form a partially thick angle-shaped boss portion around the second hole portion 36 of the link 20 in order to hold the seal member 43, and a sealing function of the seal member 43 can be maintained for a long period of time, and the link 20 can be formed to be thin and lightweight overall. Therefore, the link 20 can be formed using the rolled material 39 as a base material, which improves durability and productivity and reduces processing costs. Furthermore, the rolled material 39 can also be made thin, which reduces a material cost, making it possible to provide a low-cost link 20.

Further, by using the seal member 43 having, for example, an O-shaped, a D-shaped, or an X-shaped cross section having a larger crushing margin than that of the seal member 43 having a W-shaped cross section, even when the axial load L acts, the seal member 43 does not reach the allowable deformation amount and wear out before the end portion of the bush 21 comes into contact with the periphery of the second hole portion 36 of the link 20.

Further, by making the link 20 symmetrical or nearly symmetrical from top to bottom, excluding the bolt hole portions 28 which can be machined later, it is possible to machine both the left and right links 20 from the same rolled material 39, and therefore there is no need to prepare a dedicated rolled material for each of the left and right links 20, which further reduces the cost.

The fitting portion 45 can be easily formed by forming, as the fitting portion 45, the groove portion on at least one of the end surface of the bush 21 and the bottom portion 39 of the recess 38 of the periphery of the second hole portion 36 of the link 20, and a configuration can be easily achieved in which the axial deformation of the seal member 43 fitted into the fitting portion 45 enables the contact between the end portion or the end surface of the bush 21 and the periphery of the second hole portion 36 of the link 20 by setting the shape of the fitting portion 45 and the allowable deformation amount of the seal member 43.

Further, the track 11 includes the above-described link device 12 and the shoes 13 attached to the links 20 of the link device 12, and it is possible to provide a highly reliable track 11 which is inexpensive and capable of maintaining performance for a long period of time.

In a general link, a mud drainage hole is provided at a center of a link body, a bolt insertion hole penetrating to the mud drainage hole is provided, a mounting bolt for fixing the shoe is inserted into the bolt insertion hole of the link and a mounting hole provided in the shoe, and a nut is fastened at the mud drainage hole portion. In the case of a link for a relatively small tracked vehicle, a thickness of the link makes it easy to provide a mud drainage hole by punching or other methods, whereas in the case of a link for a relatively large tracked vehicle, the thickness makes it difficult to provide a mud drainage hole by punching. In the present embodiment, the bolt hole portion 28 is formed in a direction perpendicular to the rotation axis direction of the link 20, and the mounting bolt 27 inserted from the mounting hole 29 of the shoe 13 is screwed into the bolt hole portion 28, and thus even in the case of the track 11 for a large tracked vehicle in which it is difficult to punch a mud drainage hole in the link 20, the shoe 13 can be easily mounted on the link 20.

Next, an embodiment shown in FIG. 8 will be described. The same components as those of the embodiment illustrated in FIGS. 1 to 7 are denoted by the same reference numerals, and a description thereof is simplified.

In the present embodiment, the fitting portion 45 is a groove portion formed in the periphery of the second hole portion 36 of the link 20, that is, in the bottom portion 39 of the recess 38. Further, the fitting portion 45 is located radially away from the axial hole edge of the bush 21 and an edge portion of the second hole portion 36.

As described above, the fitting portion 45, into which the annular seal member 43 that seals the lubricant 42 interposed between the pin 22 and the bush 21 is fitted, is formed on at least one of the end portion of the bush 21 and the periphery of the second hole portion 36 of the link 20 that faces the end portion of the bush 21 via the gap 46, and by providing a configuration similar to that of the first embodiment, such as allowing the end portion of the bush 21 to be supported by the periphery of the second hole portion 36 of the link 20 by the axial deformation of the seal member 43 fitted into the fitting portion 45, the link 20 can be formed at a low cost and the lubricant 42 can be properly sealed, thereby achieving the same effects as the first embodiment.

Next, an embodiment shown in FIG. 9 will be described. The same components as the embodiments are denoted by the same reference numerals, and a description thereof is simplified.

In the present embodiment, the fitting portion 45 is a chamfered portion formed on at least one of a hole edge of the bush 21 and the edge portion of the second hole portion 36 of the link 20. In the illustrated example, the fitting portion 45 is formed mainly as a large chamfered portion on the hole edge of the bush 21 and a small chamfered portion on the edge portion of the second hole portion 36 of the link 20, and these are connected to form a triangular cross-section.

Therefore, the seal member 43 is in contact at three positions with any of three sets of a chamfered surface of the edge portion of the second hole portion 36 of the link 20 and the end surface of the bush 21, a side portion of the periphery of the second hole portion 36 of the link 20 and a chamfered surface of the axial hole edge of the bush 21, the chamfered surface of the edge portion of the second hole portion 36 of the link 20 and the chamfered surface of the axial hole edge of the bush 21, and the outer peripheral surface of the pin 22. In the fitting portion 45, a size of a triangular gap that can be formed by chamfering is set to a dimension that allows sufficient deformation of the fitted seal member 43.

As described above, the fitting portion 45, into which the annular seal member 43 that seals the lubricant 42 interposed between the pin 22 and the bush 21 is fitted, is formed on at least one of the end portion of the bush 21 and the periphery of the second hole portion 36 of the link 20 that faces the end portion of the bush 21 via the gap 46, and by providing a configuration similar to that of the first embodiment, such as allowing the end portion of the bush 21 to be supported by the periphery of the second hole portion 36 of the link 20 by the axial deformation of the seal member 43 fitted into the fitting portion 45, the link 20 can be formed at a low cost and the lubricant 42 can be properly sealed, thereby achieving the same effects as the first embodiment.

The fitting portion 45 can be easily formed by forming, as the fitting portion 45, the chamfered portion formed on at least one of the hole edge of the bush 21 and the edge portion of the second hole portion 36 of the link 20, and a configuration can be easily achieved in which the axial deformation of the seal member 43 fitted into the fitting portion 45 enables the contact between the end portion or the end surface of the bush 21 and the periphery of the second hole portion 36 of the link 20 by setting the shape of the fitting portion 45 and the allowable deformation amount of the seal member 43.

In addition to the above embodiments, the fitting portion 45 may be formed into any shape that allows the fitted seal member 43 to contact the end portion of the bush 21 and the periphery of the second hole portion 36 of the link 20, and that allows the seal member 43 to deform sufficiently in the axial direction so that the end portion of the bush 21 can be supported by the periphery of the second hole portion 36 of the link 20 due to the axial load L.

Further, the support member that supports the end portion of the bush 21 when the seal member 43 is deformed by the axial load L may not be the link 20 as long as the support member is a member harder than the seal member 43, that is, the support member is not substantially largely deformed by the load L, and the member may be, for example, a separate washer disposed around the second hole portion 36 of the link 20. That is, the present invention is not limited to the configuration in which the periphery of the second hole portion 36 of the link 20 directly contacts and supports the end portion of the bush 21, and the end portion of the bush 21 may be indirectly supported around the second hole portion 36 of the link 20 via the support member. The support member is made of a member harder than the seal member 43, and when the seal member 43 is deformed by the axial load L, the support member is brought into contact with the portion of the bush 21. Thus, the same effects as those of the respective embodiments can be achieved.

Further, the link device 12 is endless by sequentially coupling the links 20 of the same shape, but the present invention is not limited thereto, and one link 20 into which the bush 21 is fitted and another link 20 which is superimposed on the outside of the one link 20 and into which the pin 22 is press-fitted may be formed separately. In this case, a plurality of first hole portions 35 are formed in one link 20, and a plurality of second hole portions 36 are formed in the other link 20.

Further, the shoe 13 and the link 20 may be coupled by fastening with the nut and the mounting bolt using a general mud drainage hole and the bolt insertion hole, or by welding.

Further, the link device 12 is suitable for the track 11, but can also be applied to devices other than the track. For example, it is also possible to form a conveyor device by mounting rotating members such as a conveyor plate and a conveyor bar to the links 20 of the link devices 12 which are endlessly coupled.

### INDUSTRIAL APPLICABILITY

The present invention can be used in industries that manufacture and sell a track and links thereof for use in tracked vehicles such as a working machine.

1. A link device comprising:
a plurality of links formed of a rolled material and having a plurality of hole portions;
a bush press-fitted into the hole portion of the link;
a pin that couples one link and another link by being press-fitted into a hole portion of the other link through the bush press-fitted in the hole portion of the one link; and
an annular seal member that seals a lubricant interposed between the pin and the bush, wherein
a fitting portion into which the seal member is fitted is formed on at least one of an end portion of the bush and a periphery of the hole portion of the link facing the end portion of the bush via a gap, and
due to axial deformation of the seal member fitted into the fitting portion, the end portion of the bush is capable of being supported by a support member which is harder than the seal member.

2. The link device according to claim 1, wherein
the fitting portion is a groove portion formed on at least one of an end surface of the bush and a side portion of the periphery of the hole portion of the link.

3. The link device according to claim 1, wherein
the fitting portion is a chamfered portion formed on at least one of a hole edge of the bush and a hole edge of the link.

4. A track comprising:
the link device according to claim 1 in which the plurality of links are endlessly coupled via the bush and the pin; and
a shoe attached to the links of the link device.
